(19) United States
(12) Patent Application Publication
(10) Pub. No.: US 2009/0317683 A1
(43) Pub. Date: Dec. 24, 2009

(54) MEMBRANE ELECTRODE ASSEMBLY FOR FUEL CELL AND FUEL CELL

(75) Inventors: Mitsuyasu Kawahara, Susono-shi (JP); Masayoshi Takami, Hamamatsu-shi (JP); Shin Saito, Tsukuba-shi (JP); Yasuhiro Yamashita, Tsukuba-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); SUMITOMO CHEMICAL COMPANY, LIMITED, TOKYO-TO (JP)

(21) Appl. No.: 12/310,235

(22) PCT Filed: Aug. 23, 2007
(86) PCT No.: PCT/JP2007/066387

§ 371 Date: Apr. 2, 2009

(30) Foreign Application Priority Data
Aug. 25, 2006 (JP) 2006-229346

(51) Int. Cl. H01M 8/10

(52) U.S. Cl. 429/33; 429/30

(57) ABSTRACT

The present invention is to provide a membrane electrode assembly for fuel cell which retains the wet state of a polymer electrolyte membrane and has excellent output characteristic under low humidified condition, under high-temperature condition, or in high current density region, and a fuel cell provided with the membrane electrode assembly. A membrane electrode assembly for fuel cell of the present invention comprises a polymer electrolyte membrane containing at least one or more kinds of proton-conducting polymers, a fuel electrode disposed on one surface of the polymer electrolyte membrane and an oxidant electrode disposed on the other surface thereof, wherein hydrophilicity of one surface of the polymer electrolyte membrane differs from that of the other surface of the polymer electrolyte membrane, in which a surface having relatively high hydrophilicity is defined as a first surface and a surface having relatively low hydrophilicity is defined as a second surface, the fuel electrode is disposed on the first surface of the polymer electrolyte membrane, and the oxidant electrode is disposed on the second surface thereof. A fuel cell of the present invention is provided with the membrane electrode assembly.

### TECHNICAL FIELD

The present invention relates to a membrane electrode assembly for fuel cell and a fuel cell provided therewith.

### BACKGROUND ART

A fuel cell converts chemical energy directly into electrical energy by providing a fuel and an oxidant to two electrically-connected electrodes, and causing electrochemical oxidation of the fuel. Unlike thermal power, the fuel cell shows high energy conversion efficiency since it is not subject to the restriction of Carnot cycle. The fuel cell generally has a structure provided with plurality of stacked unit cells, each having a fundamental structure of a membrane electrode assembly in which an electrolyte membrane is interposed between a pair of electrodes. In particular, a solid polymer electrolyte fuel cell using a solid polymer electrolyte membrane as the electrolyte membrane has advantages in easiness to downsize and workability at low temperature and the like, and attention is hence attracted particularly to an employment of the solid polymer electrolyte fuel cell as portable and mobile power supply.

In the solid polymer electrolyte fuel cell, a reaction of formula (27) proceeds at a fuel electrode (anode).

H₂→2H⁺+2e⁻ (27)

An electron generated in the formula (27) reaches at an oxidant electrode (cathode) after passing through an external circuit and working at an outside load. Then, protons generated in the formula (27) in a state of hydration with water move inside of the solid polymer electrolyte membrane from its fuel electrode side to its oxidant electrode side by electro-osmosis.

On the other hand, a reaction of formula (28) proceeds at the oxidant electrode.

4H⁺+O₂+4e⁻→2H₂O (28)

As mentioned above, since some water molecules accompany protons generated at the fuel electrode when the protons transfer to the oxidant electrode through the solid polymer electrolyte membrane, the solid polymer electrolyte membrane and the polymer electrolyte in the electrode need to retain high wet state.

In order to retain the wet state of the solid polymer electrolyte membrane, for example, humidified reaction gas (fuel gas and/or oxidant gas) is supplied to the electrode. An auxiliary machine is often used to humidify the reaction gas, however, if the auxiliary machine is equipped, there is not only a problem that the fuel cell grows in size and system becomes complicated but also a problem that power generation efficiency lowers due to the amount of energy consumed in operation of the auxiliary machine. Also, in principle of the fuel cell, the amount of water generated at the oxidant electrode (cathode) by electrode reaction and the amount of water which accompanies protons from the fuel electrode side to the oxidant electrode side vary by operational status of the fuel cell so that it is difficult to retain the wet state constantly which is suitable for power generation. Particularly, in the case that the fuel cell is operated under high current density, so-called “flooding”, in which water remains at the oxidant electrode side, is easily caused. As a result of a supply of the oxidant being interrupted by flooding, over voltage is increased and output voltage is decreased.

Consequently, it is desired that the wet state of the solid polymer electrolyte membrane can be retained without humidifying the reaction gas or with humidifying it to a minimum. However, there is problem that the electrolyte membrane is easily dried and thus proton conductivity lowers, when operating with high current density under low humidified condition.

On the other hand, in order to increase catalyst activity of a catalytic component which accelerates the electrode reaction, it is preferable to operate the fuel cell under high-temperature condition. However, the electrolyte membrane easily becomes a dry state by evaporation of moisture in the electrolyte under high temperature operation, thus the proton conductivity declines.

Particularly, in the fuel electrode (anode) side, water is not generated by the electrode reaction and also water transfers to the oxidant electrode (cathode) side in company with protons, thus the electrolyte membrane is likely to dry.

Various arts are proposed (Patent Documents 1 to 5 or the like) for the purpose of retaining the wet state of the solid polymer electrolyte membrane and inhibiting water to remain in the electrode. For example, Patent Document 1 discloses a method of producing a membrane electrode assembly for solid polymer fuel cell, wherein after forming a proton conductivity polymer layer having EW larger than that of a solid polymer electrolyte membrane on a cathode catalyst layer and a proton conductivity polymer layer having EW smaller than that of the solid polymer electrolyte membrane on an anode catalyst layer, electrodes having the catalyst layers and the solid polymer electrolyte membrane are bound together under heating and pressure.

In addition, Patent Document 2 discloses a solid polymer fuel cell, wherein a hydrophilic layer is formed between a polymer electrolyte membrane and an anode side catalyst layer or a cathode side catalyst layer. An embodiment, wherein the hydrophilic layer is formed in such a manner that a surface of the polymer electrolyte membrane in which the anode side catalyst layer or the cathode side catalyst layer is laminated is subjected to hydrophilization by electron irradiation, is proposed.

Patent Document 1: Japanese Patent Application Laid-open (JP-A) No. H11-40172

Patent Document 2: JP-A No. 2005-25974

Patent Document 3: JP-A No. H10-284087

Patent Document 4: JP-A No. 2003-272637

Patent Document 5: JP-A No. 2005-317287

### DISCLOSURE OF INVENTION

According to the art disclosed in Patent Document 1, by the proton conductivity polymer layer which is formed between the polymer electrolyte membrane and the catalyst layer, the transfer of water accompanying protons to the oxidant electrode (cathode) may be prevented, water accumulation in the catalyst layer may be inhibited, and also drying of the polymer electrolyte membrane may be prevented. However, in the case that sufficient binding between the proton conductivity polymer layer and the electrolyte membrane is hardly obtained, there is a problem that over voltage is caused and output voltage is decreased. Also, water distribution in the polymer electrolyte membrane becomes nonuniform between the fuel electrode side and the oxidant electrode side and drying of the fuel electrode side can not be sufficiently prevented, so that there is a possibility that power generation characteristic can not be improved. Further, a process of forming the proton conductivity polymer layer is added, thus productivity is reduced.

On the other hand, the art which is disclosed in Patent Document 2 shows that water generated in the cathode side catalyst layer is brought back to the polymer electrolyte membrane and is utilized for humidification of the polymer electrolyte membrane by providing the hydrophilic layer with higher hydrophilicity than that of the catalyst layer between the polymer electrolyte membrane and the catalyst layer. Further, the art shows that it is preferable that the hydrophilic layer is provided between the polymer electrolyte membrane and the cathode side catalyst layer to maximize this effect and only discloses embodiments in which the hydrophilic layer is provided on both surfaces of cathode side and anode side of the solid polymer electrolyte membrane as examples. As above, in the case that the hydrophilic layer is provided on the cathode side, the water distribution in the polymer electrolyte membrane becomes nonuniform between the anode side and the cathode side, and drying of the anode side can not be sufficiently prevented, so that there is a possibility that power generation characteristic can not be improved.

The present invention has been achieved in view of the above circumstances, and it is an object of the present invention to provide a membrane electrode assembly for fuel cell which retains the wet state of the polymer electrolyte membrane and has excellent output characteristic under low humidified condition, under high-temperature condition, or in high current density region, and a fuel cell provided with the membrane electrode assembly.

### MEANS FOR SOLVING THE PROBLEM

A membrane electrode assembly for fuel cell (hereinafter, it may be referred to as a membrane electrode assembly) of the present invention comprises a polymer electrolyte membrane containing at least one or more kinds of proton-conducting polymers, a fuel electrode disposed on one surface of the polymer electrolyte membrane and an oxidant electrode disposed on the other surface thereof, wherein hydrophilicity of one surface of the polymer electrolyte membrane differs from that of the other surface of the polymer electrolyte membrane, in which a surface having relatively high hydrophilicity is defined as a first surface and a surface having relatively low hydrophilicity is defined as a second surface, the fuel electrode is disposed on the first surface of the polymer electrolyte membrane, and the oxidant electrode is disposed on the second surface thereof.

In the membrane electrode assembly of the present invention, by providing the surface of the polymer electrolyte membrane having relatively high hydrophilicity on the fuel electrode side and the surface of the polymer electrolyte membrane having relatively low hydrophilicity on the oxidant electrode side with the use of the polymer electrolyte membrane, one surface of which has different hydrophilicity from the other surface, the transfer of water (back diffusion) from the oxidant electrode side to the fuel electrode side in the polymer electrolyte membrane is facilitated and water distribution is uniformly formed in the thickness direction of the polymer electrolyte membrane.

Accordingly, drying of the electrolyte membrane and the electrode, which is easily caused at the fuel electrode side, can be inhibited and the wet state of the polymer electrolyte membrane and the fuel electrode can be retained under the condition that drying of the polymer electrolyte membrane and the fuel electrode is easily caused such as operation under low humidified condition, under high-temperature condition, or in high current density region, therefore electric performance can be improved.

The hydrophilicity of the surface of the polymer electrolyte membrane can be specified, for example, by water contact angle, wherein the water contact angle on the first surface is relatively small and the water contact angle on the second surface is relatively large.

When the hydrophilicity of the surface of the polymer electrolyte membrane is specified by the water contact angle, it is preferable that a difference of water contact angle between the first surface and the second surface is larger than 30° to sufficiently facilitate the transfer of water (back diffusion) from the oxidant electrode side to the fuel electrode side in the polymer electrolyte membrane.

A specific value of the water contact angle on the first surface and the second surface is not particularly limited, however, the water contact angle on the first surface is preferably from 10° to 60°, and the water contact angle on the second surface is preferably 6° or more. In addition, the water contact angle on the second surface is preferably 100° or less.

As material constituting the polymer electrolyte membrane, for example, there may be a hydrocarbon polymer electrolyte membrane.

As the proton-conducting polymer constituting the polymer electrolyte membrane, it is preferable that the proton-conducting polymer has an aromatic ring in a main chain and a proton-exchange group which is bonded to the aromatic ring directly or indirectly through one or more other atoms or atomic groups. The proton-conducting polymer may have a side chain.

In addition, it is preferable that the proton-conducting polymer has an aromatic ring in a main chain and may further have a side chain with an aromatic ring, and at least one of the aromatic rings of the main chain or the side chain has the proton-exchange group which is directly bonded to the aromatic ring.

As the proton-exchange group, a sulfonic acid group is suitable.

Further, as the specific aforementioned proton-conducting polymer, there may be a proton-conducting polymer containing one or more repeating units having the proton-exchange group selected from the following formulas (1a) to (4a) and one or more repeating units substantially having no proton-exchange group selected from the following formulas (1b) to (4b):

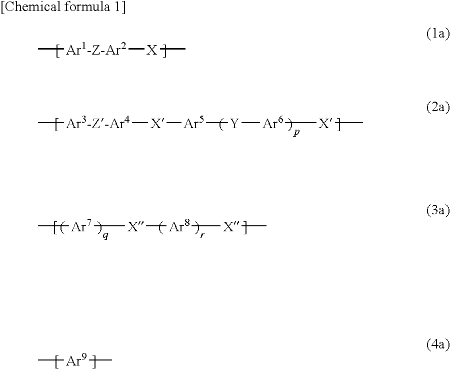

wherein, each of from Ar¹ to Ar⁹ represents a divalent aromatic group having an aromatic ring in a main chain and may further have a side chain with an aromatic ring; at least one of the aromatic rings of the main chain or the side chain has a proton-exchange group which is directly bonded to the aromatic ring; each of “Z” and “Z′” independently represents either CO or SO₂; each of “X”, “X′” and “X″” independently represents either O or S; “Y” represents a direct bonding or a methylene group which may have a substituent; “p” represents 0, 1 or 2; and each of “q” and “r” independently represents 1, 2 or 3, and

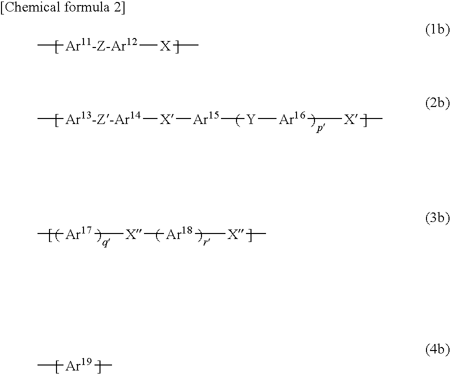

wherein, each of from Ar¹¹ to Ar¹⁹ independently represents a divalent aromatic group which may have a substituent as a side chain; each of “Z” and “Z′” independently represents either CO or SO₂; each of “X”, “X′” and “X″” independently represents either O or S; “Y” represents a direct bonding or a methylene group which may have a substituent; “p′” represents 0, 1 or 2; each of “q′” and “r′” independently represents 1, 2 or 3.

The proton-conducting polymer is preferably a block copolymer containing a block (A) having the proton-exchange group and a block (B) substantially having no proton-exchange group since a microphase-separated structure to be hereinafter described is easily formed in the polymer electrolyte membrane.

In the case that the polymer electrolyte membrane has the microphase-separated structure separated into at least two or more phases, the hydrophilicity of both surfaces of the polymer electrolyte membrane is easily controlled.

As the polymer electrolyte membrane having the microphase-separated structure, there may be a polymer electrolyte membrane which comprises the block copolymer containing the block (A) having the proton-exchange group and the block (B) substantially having no proton-exchange group as the proton-conducting polymer, and has the microphase-separated structure containing a phase with high density of the block (A) having the proton-exchange group and a phase with high density of the block (B) substantially having no proton-exchange group.

Specifically, as the proton-conducting polymer, there may be a proton-conducting polymer which contains one or more blocks (A) having the proton-exchange group and one or more blocks (B) substantially having no proton-exchange group, in which the block (A) having the proton-exchange group has a repeating structure represented by the following formula (4a′), and the block (B) substantially having no proton-exchange group has one or more repeating structures selected from repeating structures represented by the following formula (1b′), (2b′) or (3b′):

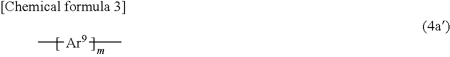

wherein, “m” represents an integer of 5 or more; Ar⁹ represents a divalent aromatic group; the divalent aromatic group as used herein may be substituted by a fluorine atom, an alkyl group having 1 to 10 carbons, an alkoxy group having 1 to 10 carbons, an aryl group having 6 to 18 carbons, an aryloxy group having 6 to 18 carbons or an acyl group having 2 to 20 carbons; and Ar⁹ has at least one proton-exchange group which is bonded to an aromatic ring constituting a main chain directly or indirectly through a side chain, and

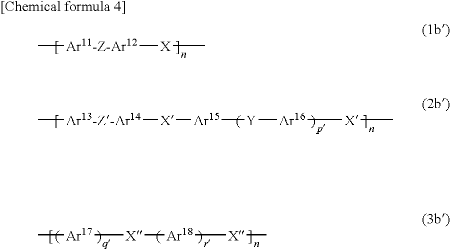

wherein, “n” represents an integer of 5 or more; each of from Ar¹¹ to Ar¹⁸ independently represents a divalent aromatic group; the divalent aromatic group as used herein may be substituted by an alkyl group having 1 to 18 carbons, an alkoxy group having 1 to 10 carbons, an aryl group having 6 to 10 carbons, an aryloxy group having 6 to 18 carbons or an acyl group having 2 to 20 carbons; other symbols are the same as shown in the formulas (1b) to (3b).

In addition, as the proton-conducting polymer, there may be a proton-conducting polymer which contains one or more blocks (A) having the proton-exchange group and one or more blocks (B) substantially having no proton-exchange group, and the proton-exchange group is directly bonded to the aromatic ring in the main chain of the block having the proton-exchange group.

Further, as the proton-conducting polymer, there may be a proton-conducting polymer which contains one or more blocks (A) having the proton-exchange group and one or more blocks (B) substantially having no proton-exchange group, and both block (A) having the proton-exchange group and block (B) substantially having no proton-exchange group have no substituent containing a halogen atom.

As the polymer electrolyte membrane, from the viewpoint of productivity and chemical or physical deterioration of the polymer electrolyte membrane, no surface treatment is preferably carried out on the second surface. Particularly, no surface treatment is preferably carried out on both first surface and second surface.

The polymer electrolyte membrane suitably used is formed by casting, coating and drying a solution containing the proton-conducting polymer constituting the polymer electrolyte membrane on a substrate.

As the substrate, a substrate whose surface subject to casting and coating is formed by a resin can be used. Typically, a substrate made of a resin film may be used. As the resin film, there may be a polyester film.

According to the above-mentioned membrane electrode assembly of the present invention, a fuel cell which has excellent power generation characteristic under the condition that drying of the polymer electrolyte membrane is easily caused, and which can be operated under wide range of humidified conditions from low to high, in high current density region, or further under high-temperature condition, can be provided.

### EFFECT OF THE INVENTION

According to the membrane electrode assembly of the present invention, a membrane electrode assembly for fuel cell which retains the wet state of the solid polymer electrolyte membrane and has excellent output characteristic under low humidified condition, under high-temperature condition, or in high current density region, and a fuel cell provided with the membrane electrode assembly can be proposed.

### BRIEF DESCRIPTION OF DRAWINGS

In the accompanying drawings,

FIG. 1 is a view showing an embodiment of a unit cell provided with a membrane electrode assembly of the present invention;

FIG. 2 is a graph showing results of (1) electric performance test under high humidified condition of Example 1 and Comparative example 1; and

FIG. 3 is a graph showing results of (2) electric performance test under low humidified condition of Example 1 and Comparative example 1.

The numerical symbol in each figure refers to the following:
1: polymer electrolyte membrane
2: fuel electrode
3: oxidant electrode
4a: fuel electrode side catalyst layer
4b: oxidant electrode side catalyst layer
5a: fuel electrode side gas diffusion layer
5b: oxidant electrode side gas diffusion layer
6: membrane electrode assembly
7a: fuel electrode side separator
7b: oxidant electrode side separator
8a, 8b: passage
100: unit cell.

### BEST MODE FOR CARRYING OUT THE INVENTION

A membrane electrode assembly for fuel cell comprises a polymer electrolyte membrane containing at least one or more kinds of proton-conducting polymers, a fuel electrode disposed on one surface of the polymer electrolyte membrane and an oxidant electrode disposed on the other surface thereof, wherein hydrophilicity of one surface of the polymer electrolyte membrane differs from that of the other surface of the polymer electrolyte membrane, in which a surface having relatively high hydrophilicity is defined as a first surface and a surface having relatively low hydrophilicity is defined as a second surface, the fuel electrode is disposed on the first surface of the polymer electrolyte membrane, and the oxidant electrode is disposed on the second surface thereof.

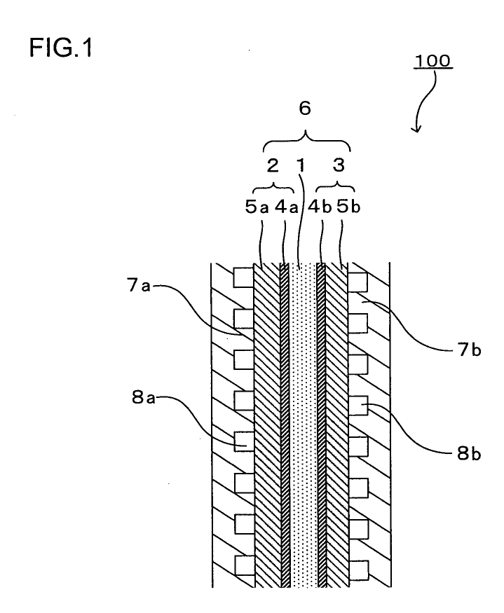

FIG. 1 is a schematic drawing of an embodiment of the membrane electrode assembly for fuel cell of the present invention. In FIG. 1, a unit cell 100 for fuel cell (hereinafter, it may be simply referred to as a unit cell) is provided with the membrane electrode assembly 6 wherein the fuel electrode (anode) 2 is disposed on one surface of the polymer electrolyte membrane 1, and the oxidant electrode (cathode) 3 is disposed on the other surface of the polymer electrolyte membrane 1. In the embodiment of the present invention, the fuel electrode 2 and the oxidant electrode 3 have a structure that a fuel electrode side catalyst layer 4a and a fuel electrode side gas diffusion layer 5a, and an oxidant electrode side catalyst layer 4b and an oxidant electrode side gas diffusion layer 5b are respectively laminated in this order from the electrolyte membrane side.

The catalyst layers 4a and 4b of each electrode (fuel electrode, oxidant electrode) contains an electrode catalyst having catalyst activity (not shown) for the electrode reaction and it serves as a site of an electrode reaction. The gas diffusion layers 5a and 5b are provided for enhancing a power collection performance of the electrode and diffuseness of the reaction gas to the catalyst layer 4.

In the present invention, structures of each electrode are not limited to the structures as shown in FIG. 1. It may be a structure comprising catalyst layer alone or a structure provided with one or more layers other than the catalyst layer and the gas diffusion layer.

The membrane electrode assembly 6 is interposed between a fuel electrode side separator 7a and an oxidant electrode side separator 7b so as to constitute the unit cell 100 for fuel cell. Each of the separators 7 defines a passage 8 (8a, 8b) which supplies the reaction gas (fuel gas, oxidant gas) to the electrode 2 or 3, functions a gas seal between unit cells, and functions as a collector. The fuel gas (gas which contains or generates hydrogen, generally hydrogen gas) is supplied to the fuel electrode 2 through the passage 8a. The oxidant gas (gas which contains or generates oxygen, generally air) is supplied to the oxidant electrode 3 through the passage 8b. By the reaction of the fuel and oxidant, the fuel cell produces electricity.

Generally, the unit cell 100 is plurally stacked and stacks are incorporated into the fuel cell.

The membrane electrode assembly of the present invention is quite characterized in that the polymer electrolyte membrane 1, hydrophilicity of one surface of which differs from that of the other surface, is used, and that the oxidant electrode 3 is disposed on the surface having relatively low hydrophilicity and the fuel electrode 2 is disposed on the surface having relatively high hydrophilicity.

As mentioned above, generally, drying of the membrane electrode assembly is easily caused at the fuel electrode (anode) side compared to the oxidant electrode (cathode) side. This is because protons generated at the fuel electrode transfer to the oxidant electrode side accompanying water, and water is generated at the oxidant electrode by the electrode reaction.

A part of moisture in the oxidant electrode diffuses in the form of back diffusion into the fuel electrode side through the polymer electrolyte membrane (hereinafter, it may be simply referred to as an electrolyte membrane) and utilizes for moisture retention of the electrolyte membrane and moisture accompanying the protons. The inventors of the present invention have found that the amount of moisture which transfers from the polymer electrolyte membrane to the oxidant electrode is decreased, the amount of moisture which is retained in the polymer electrolyte membrane is ensured, and nonuniformity of moisture distribution of the fuel electrode side and the oxidant electrode side in the polymer electrolyte membrane is improved, by facilitating back diffusion of moisture from the oxidant electrode side to the fuel electrode side in the polymer electrolyte membrane.

Further, the inventors of the present invention have focused attention on a difference of hydrophilicity on both surfaces of the polymer electrolyte membrane, namely the oxidant electrode side and the fuel electrode side, as a driving force of back diffusion of water from the oxidant electrode side to the fuel electrode side. Then, the inventors have found that it is possible to facilitate the back diffusion of water from the oxidant electrode side to the fuel electrode side in the polymer electrolyte membrane by using the polymer electrolyte membrane, hydrophilicity of one surface of which differs from that of the other surface, and disposing the fuel electrode on the surface having relatively high hydrophilicity and the oxidant electrode on the surface having relatively low hydrophilicity.

The surface of the electrolyte membrane on the oxidant electrode side is positioned at downstream side of proton conduction, and further, moisture easily transfers therein from the adjacent oxidant electrode. A lot of moisture can be transferred from the oxidant electrode side to the fuel electrode side by lowering the hydrophilicity of the surface of the electrolyte membrane on the oxidant electrode side, which easily collects moisture as mentioned above, in comparison with the hydrophilicity of the surface of the electrolyte membrane on the fuel electrode side. In addition, by facilitating the transfer of water from the oxidant electrode side to the fuel electrode side in the electrolyte membrane, the amount of water which transfers from the oxidant electrode side of the electrolyte membrane to the oxidant electrode can be reduced.

As mentioned above, according to the membrane electrode assembly of the present invention, the amount of water to be retained in the electrolyte membrane can be ensured and the distribution state of water in the thickness direction of the electrolyte membrane can be uniformized. Further, the wet state in the adjacent fuel electrode can be retained high by inhibiting drying of the fuel electrode side of the polymer electrolyte membrane, thus improvement of the proton conductivity in the fuel electrode can be expected.

Thereby, even in the operation of the fuel cell under the condition that the fuel electrode particularly easily dries such as under high-temperature condition, under low humidified condition or in high current density region or the like, the wet state of the polymer electrolyte membrane can be retained and the electrolyte membrane exhibits stable proton conductivity.

Therefore, according to the membrane electrode assembly for fuel cell of the present invention, it is possible to inhibit decrease in the proton conductivity due to the drying of the polymer electrolyte membrane and the fuel electrode, and a fuel cell which has excellent power generation characteristic can be provided.

The terms “having relatively low hydrophilicity” and “having relatively high hydrophilicity” used in the present invention refer to low and high of hydrophilicity which are relative comparison of hydrophilicity of one surface and the other surface of the electrolyte membrane. Hereinafter, when simply referred as “hydrophilicity is high” and “hydrophilicity is low”, high and low are used in a relative sense as mentioned above.

Also, the terms “water contact angle is relatively small” and “water contact angle is relatively large” used in the present invention refer to small and large of water contact angle which are relative comparison of water contact angle of one surface and the other surface of the electrolyte membrane. Hereinafter, when simply referred as “water contact angle is small” and “water contact angle is large”, small and large are used in a relative sense as mentioned above.

Hereinafter, the polymer electrolyte membrane used in the membrane electrode assembly of the present invention will be described in detail.

In the membrane electrode assembly of the present invention, the polymer electrolyte membrane having different hydrophilicity on one surface and the other surface is used. The fuel electrode is disposed on the surface having relatively high hydrophilicity (the first surface) and the oxidant electrode is disposed on the surface having relatively low hydrophilicity (the second surface).

A method to specify hydrophilicity on the first surface and the second surface of the polymer electrolyte membrane is not particularly limited. However, for example, it can be specified by small and large of the water contact angle.

The water contact angle on the surface of the polymer electrolyte membrane as used herein is a value obtained by leaving the polymer electrolyte membrane for 24 hours in an atmosphere at 23° C. under 50 RH % followed by putting a drop of water having a diameter of 2.0 mm on the surface of the polymer electrolyte membrane, and then calculating out the contact angle with respect to the drop after 5 seconds by sessile drop method by means of contact angle measuring system (for example, CA-A type, manufactured by Kyowa Interface Science Co., Ltd.).

The water contact angle of the surface of the polymer electrolyte membrane surface provides an indication of hydrophilicity of the polymer electrolyte membrane surface, wherein the smaller contact angle means the higher hydrophilicity, and the larger contact angle means the lower hydrophilicity. That is, in the polymer electrolyte membrane used in the present invention, the first surface having high hydrophilicity has small water contact angle, and the second surface having low hydrophilicity has large water contact angle. A measurement of water contact angle is a comparatively simple method and is suitable as a means to evaluate hydrophilicity of the polymer electrolyte membrane surface.

The water contact angle on the first surface (hereinafter, it may be referred as to θ₁) of the polymer electrolyte membrane on which the fuel electrode is disposed and the water contact angle on the second surface (hereinafter, it may be referred as to θ₂) of the polymer electrolyte membrane on which the oxidant electrode is disposed are not limited to the specific value if θ₁ is smaller than θ₂ when θ of the first surface and the second surface are compared.

However, to obtain sufficient effect of the present invention, that is, to sufficiently facilitate the transfer of water from the second surface having large water contact angle (hydrophilicity is low) on which the oxidant electrode is disposed to the first surface having small water contact angle (hydrophilicity is high) on which the fuel electrode disposed, it is preferable that a difference between θ₁ and θ₂ is larger than 30° (θ₂−θ₁>30°).

In addition, under condition of θ₁<θ₂, the water contact angle θ₁ of the first surface of the polymer electrolyte membrane is preferably from 10° to 60°, particularly preferably from 20° to 50°, from the viewpoint of adhesion to the electrode and stability of shape. The water contact angle θ₂ of the second surface of the polymer electrolyte membrane is preferably 60° or more, particularly preferably 70° or more, and preferably 100° or less, particularly preferably 100° or less, from the viewpoint of adhesion to the substrate during and after production, blocking prevention between membranes when the membrane is reeled in the form of scroll, and adhesion with the electrode.

It is preferable if θ₁ is 10° or more since the surface of the polymer electrolyte membrane has moderate hydrophilicity and the stability of shape at the time of water absorption becomes better, and if θ₁ is 60° or less since adhesion between produced polymer electrolyte membrane and electrode becomes higher.

On the other hand, it is preferable if θ₂ is 60° or more since adhesion between the polymer electrolyte membrane and the substrate becomes better during and after production, and the blocking, in which the membranes adhere each other when the membrane is reeled in the form of scroll, is less likely to be caused between membranes, and if θ₂ is 100° or less since adhesion between the produced polymer electrolyte membrane and the electrode becomes further higher due to high wettability of the surface, and property as the polymer electrolyte membrane for fuel cell improves.

The proton-conducting polymer which composes the polymer electrolyte membrane is not particularly limited if it has a proton-exchange group and exhibits the proton conductivity. Generally, a proton-conducting polymer which is used for the solid polymer fuel cell can be used. As the proton-conducting polymer which composes the polymer electrolyte membrane, it may be used alone or in combination of two or more.

The polymer electrolyte membrane preferably contains 50 wt % or more proton-conducting polymers, more preferably 70 wt % or more, particularly preferably 90 wt % or more.

An introduction amount of the proton-exchange group, which conducts proton in the polymer electrolyte membrane, is preferably from 0.5 meq/g to 4.0 meq/g, more preferably from 1.0 meq/g to 2.8 meq/g expressed as an ion-exchange capacity. It is preferable that the ion-exchange capacity, which refers to the introduction amount of the proton-exchange group, is 0.5 meq/g or more since the proton conductivity becomes higher and a function as polymer electrolyte for fuel cell becomes better. On the other hand, it is preferable that the ion-exchange capacity, which refers to the introduction amount of the proton-exchange group, is 4.0 meq/g or less since water resistance becomes much better.

As the proton-conducting polymer, for example, there may be a hydrocarbon polymer electrolyte or the like.

The hydrocarbon polymer electrolyte as used herein does not typically contain any fluorine, however, it may be partially substituted by fluorine. Examples of the hydrocarbon polymer electrolyte are an engineering plastic having an aromatic main chain such as polyether ether ketone, polyether ketone, polyether sulfone, polyphenylene sulfide, polyphenylene ether, polyether ether sulfone, poly(p-phenylene) or polyimide, and a general-purpose plastic such as polyethylene or polystyrene having a proton-exchange group such as a sulfonic acid group, a carboxylic acid group, a phosphate group, a phosphonic acid group or a sulfonyl imide group introduced. The hydrocarbon polymer electrolyte may have a side chain. As the proton-exchange group, the sulfonic acid group is preferable.

The hydrocarbon polymer electrolyte has an advantage that cost is low compared with that of fluorinated polymer electrolyte. Especially, an aromatic hydrocarbon polymer electrolyte having the proton-exchange group introduced to the aromatic hydrocarbon polymer having the aromatic ring in the main chain is preferable from the viewpoint of heat resistance. In the case of the aromatic hydrocarbon polymer electrolyte, an aromatic hydrocarbon polymer electrolyte having an aromatic ring in the main chain and a proton-exchange group which is bonded to the aromatic ring directly or indirectly through other atoms or atomic groups, and an aromatic hydrocarbon polymer electrolyte having an aromatic ring in the main chain, optionally having a side chain with an aromatic ring, in which at least one of the aromatic rings of the main chain or the side chain has the proton-exchange group which is directly bonded to the aromatic ring, are preferable.

In the present invention, as the polymer electrolyte membrane, the hydrocarbon polymer electrolyte membrane containing the hydrocarbon polymer electrolyte is preferable. Particularly, the hydrocarbon polymer electrolyte membrane containing 50 wt % or more of hydrocarbon polymer electrolyte is preferable, further the hydrocarbon polymer electrolyte membrane containing 80 wt % or more of hydrocarbon polymer electrolyte is preferable. However, other polymers, a proton-conducting polymer which is not hydrocarbon type, and additives or the like may be contained in the range that the effect of the present invention is not prevented.

In the present invention, difference of hydrophilicity of both surfaces of the polymer electrolyte membrane may be imparted in any manner. However, coating and laminating the proton-conducting polymers having different hydrophilicity on the first surface and/or the second surface is not included. The polymer electrolyte membrane used in the membrane electrode assembly of the present invention is typically formed into a membrane by using one composition containing at least one or more kinds of the proton-conducting polymers.

In the polymer electrolyte membrane, both surfaces of which has different hydrophilicity by coating or laminating substances having desirable hydrophilicity, for example, a plurality of proton-conducting polymers, adhesion property of an interface at a coated or laminated part is often insufficient and peeling on the interface is easily caused, thus decrease in the proton conductivity and in voltage or the like may be caused. The surface treatment or the like may be carried out on the surface of the membrane. It is preferable not to carryout the surface treatment since the chemical deterioration may be caused.

From the viewpoint of shortening of the production process and prevention of chemical or physical deterioration of the polymer electrolyte membrane caused by surface treatment, the polymer electrolyte membrane, both surfaces of which have different contact angle with respect to water, not subject to a post-process of the surface treatment or the like, is preferable.

When the polymer electrolyte membrane is produced by a so-called solution-cast method, by casting a solution containing the proton-conducting polymer (polymer electrolyte solution) on the surface of an appropriate substrate, difference of contact angle (difference of hydrophilicity) can be made between both surfaces of the polymer electrolyte membrane without carrying out the post-process such as the surface treatment or the like after forming membrane. More specifically, sufficient difference of hydrophilicity can be made between both surfaces of the membrane without carrying out a special surface treatment on the second surface, which serves as a contact surface with the substrate upon flow casting, and the first surface, which serves as a contact surface with air upon the flow casting, after forming the membrane by the solution-cast method. However, in order to further optimize the difference of contact angle obtained by the process of forming membrane, the surface treatment may be carried out on the first surface and/or the second surface.

Control of the contact angle with respect to water on the surface of the polymer electrolyte membrane by the solution-cast method is considered as below. It is presumed that the difference between the water contact angle on the second surface which serves as the contact surface with a substrate and the water contact angle on the first surface which serves as the contact surface with air upon flow casting is caused by difference between interaction between solution-state polymer electrolyte and substrate and interaction between solution-state polymer electrolyte and air in the solution-cast method depending on a combination of constituent materials of the polymer electrolyte membrane containing the proton-conducting polymer and the substrate.

By casting and coating the polymer electrolyte solution on the surface of appropriate substrate, the contact angle on the substrate side of coating membrane obtained can be easily made larger than the contact angle on the other side (air surface side) by the interaction between the polymer electrolyte and the substrate. That is, the contact surface with the substrate of the polymer electrolyte membrane serves as the second surface having large contact angle with respect to water, and the contact surface with air of the polymer electrolyte membrane serves as the first surface having small contact angle with respect to water.

Since the control of the water contact angle by the above-mentioned solution-cast method, which does not include the surface treatment process, enables shortening of the production process by comparison with the case of carrying out the post-process such as the surface treatment, it has great advantage in industrial use. Also, when the surface treatment or the like is carried out, chemical or physical deterioration of the polymer electrolyte membrane may be likely to be caused.

As the proton-conducting polymer constituting the polymer electrolyte membrane, both surfaces of which are differentiated in water contact angle by forming the membrane by the solution-cast method (not subjected to post-process), the above-mentioned proton-conducting polymer electrolyte can be used. In particular, the aromatic hydrocarbon polymer electrolyte which has the proton-exchange group introduced to the aromatic hydrocarbon polymer is preferable. It is particularly preferable that the aromatic hydrocarbon polymer electrolyte has the aromatic ring in the main chain and the proton-exchange group which is bonded to the aromatic ring directly or indirectly through one or more other atoms or atomic groups. The aromatic hydrocarbon polymer electrolyte may have the side chain or the substituent. In addition, as a preferred aromatic hydrocarbon polymer electrolyte in the present invention, there may be the aromatic hydrocarbon polymer electrolyte having the aromatic ring in the main chain, optionally having the side chain with the aromatic ring, in which at least one of the aromatic rings of the main chain or the side chain has the proton-exchange group which is bonded directly or indirectly through other atoms to the aromatic ring. As the proton-exchange group, a sulfonic acid group is preferable.

Hereinafter, the aromatic hydrocarbon polymer electrolyte will be described further in detail.

The proton-conducting polymer containing a copolymer by random copolymerization, block copolymerization, graft copolymerization or alternating copolymerization is preferable. A block copolymer and a graft copolymer having one or more polymer segments with the proton-exchange group and one or more polymer segments substantially having no proton-exchange group are more preferable. Further preferably, there may be a block copolymer having one or more blocks (A) having the proton-exchange group and one or more blocks (B) substantially having no proton-exchange group.

In addition, further preferably, there may be a block copolymer having one or more blocks (A) having the proton-exchange group and one or more blocks (B) substantially having no proton-exchange group, and the proton-exchange group is directly bonded to the aromatic ring in the main chain of the block having the proton-exchange group.

In the present invention, a polymer, polymer segment, block or a repeating unit “substantially has a proton-exchange group” means that the segment contains an average of 0.5 or more proton-exchange groups per repeating unit, preferably an average of 1.0 or more proton-exchange groups per repeating unit. On the other hand, a polymer, polymer segment, block or a repeating unit “substantially has no proton-exchange group” means that the segment contains an average of 0.5 or less proton-exchange groups per repeating unit, preferably an average of 0.1 or less per repeating unit, further preferably an average of 0.05 or less per repeating unit.

In the case that the proton-conducting polymer used in the present invention contains the block copolymer, the block copolymer preferably comprises the block (A) having the proton-exchange group and the block (B) substantially having no proton-exchange group.

It is preferable that the proton-conducting polymer used in the present invention contains the block copolymer since a microphase-separated structure separated into at least two or more phases is easily formed. The term “microphase-separated structure” as used herein means a structure which is formed by microscopic phase separation with order of molecular chain size since different kinds of polymer segments are chemically bonded in the block copolymer or the graft copolymer. For example, when viewing the structure by means of a transmission electron microscope (TEM), the “microphase-separated structure” shows that a microscopic phase (microdomain) with high density of the block (A) having the proton-exchange group and a microscopic phase (microdomain) with high density of the block (B) substantially having no proton-exchange group are mixed and domain width of each microdomain structure, that is, identity period is in the range of several nm to several 100 nm. Preferably, there may be a microphase-separated structure having a microdomain structure in the range of 5 nm to 100 nm.

As for the reason that the polymer electrolyte membrane having the microphase-separated structure is preferable, the following hypothesis can be considered: the contact angle is controlled by strong interaction such as affinity or repulsive force between the proton-conducting polymer and the substrate when casting and coating the polymer electrolyte solution in the solution-cast method since the microphase-separated structure has microscopic aggregate.

Examples of the proton-conducting polymer used in the polymer electrolyte membrane of the present invention are structures with reference to Patent Document 6 (JP-A. No. 2005-126684) and Patent Document 7 (JP-A No. 2005-206807).

More specifically, the proton-conducting polymer comprises one or more repeating units having the proton-exchange group selected from the formulas (1a), (2a), (3a) and (4a) and one or more repeating units substantially having no proton-exchange group selected from the formulas (1b), (2b), (3b) and (4b) as repeating units. Examples of polymerization are block copolymerization, alternating copolymerization and random copolymerization.

An example of preferred block copolymer in the present invention is a block copolymer comprising one or more kinds of blocks containing a repeating unit having the proton-exchange group selected from the formulas (1a), (2a), (3a) and (4a) and one or more kinds of blocks containing a repeating unit substantially having no proton-exchange group selected from the formulas (1b), (2b), (3b) and (4b). More preferably, there may be a copolymer comprising the following blocks:

<I>. the block containing the repeating unit (1a) and the block containing the repeating unit (1b);
<II>. the block containing the repeating unit (1a) and the block containing the repeating unit (2b);

<III>. the block containing the repeating unit (2a) and the block containing the repeating unit (1b);

<IV>. the block containing the repeating unit (2a) and the block containing the repeating unit (2b);
<V>. the block containing the repeating unit (3a) and the block containing the repeating unit (1b);
<VI>. the block containing the repeating unit (3a) and the block containing the repeating unit (2b);
<VII>. the block containing the repeating unit (4a) and the block containing the repeating unit (1b); and
<VII>. the block containing the repeating unit (4a) and the block containing the repeating unit (2b).

The copolymer comprising the above <II>, <III>, <IV>, <VII>, <VIII> or the like is further preferable. The copolymer comprising the above <VII>, <VIII> or the like is particularly preferable.

In the more preferred block copolymer of the present invention, the repeating number of (4a), which is “m” in the formula (4a′), represents an integer of 5 or more, preferably in the range from 5 to 1,000, and more preferably in the range from 10 to 500. It is preferable if value of “m” is 5 or more since proton conductivity is sufficient as the polymer electrolyte for fuel cell. It is preferable if the value of “m” is 1,000 or less since production is easier.

Ar⁹ in the formula (4a′) represents a divalent aromatic group. Examples of the divalent aromatic group are divalent monocyclic aromatic groups such as 1,3-phenylene and 1,4-phenylene, divalent condensed aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl and 2,7-naphthalenediyl, and heteroaromatic groups such as pyridinediyl, quinoxalinediyl and thiophenediyl. The divalent monocyclic aromatic groups are preferable.

Also, Ar⁹ may be substituted by a fluorine atom, an alkyl group having 1 to 10 carbons which may have a substituent, an alkoxy group having 1 to 10 carbons which may have a substituent, an aryl group having 6 to 18 carbons which may have a substituent, an aryloxy group having 6 to 18 carbons which may have a substituent or an acyl group having 2 to 20 carbons which may have a substituent.

Ar⁹ has at least one proton-exchange group which is bonded to the aromatic ring constituting the main chain directly or indirectly through the side chain. As the proton-exchange group, an acid group (cation exchange group) is more preferable. Preferable examples are a sulfonic acid group, a phosphonic acid group and a carboxylic acid group. Among them, the sulfonic acid group is more preferable.

Each of these proton-exchange groups may be partially or completely substituted by a metallic ion or the like to form salt. However, it is preferable that these proton-exchange groups are substantially in the state of free acid.

A preferred example of the repeating unit represented by the formula (4a′) is the following formula:

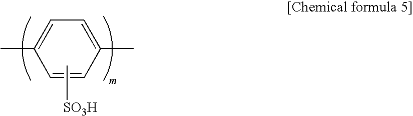

In the more preferred block copolymer of the present invention, the repeating number of (1b) to (3b), which is “n” in the formula (1b′) to (3b′), represents an integer of 5 or more, preferably in the range from 5 to 1,000, and more preferably in the range from 10 to 500. It is preferable if value of “n” is 5 or more since proton conductivity is sufficient as the polymer electrolyte for fuel cell. It is preferable if the value of “n” is 1,000 or less, since production is easier.

Each of Ar¹¹ to Ar¹⁸ in the formula (1b′) to (3b′) independently represents a divalent aromatic group. Examples of the divalent aromatic group are divalent monocyclic aromatic groups such as 1,3-phenylene and 1,4-phenylene, divalent condensed aromatic groups such as 1,3-naphthalenediyl, 1,4-naphthalenediyl, 1,5-naphthalenediyl, 1,6-naphthalenediyl, 1,7-naphthalenediyl, 2,6-naphthalenediyl and 2,7-naphthalenediyl, and heteroaromatic groups such as pyridinediyl, quinoxalinediyl and thiophenediyl. The divalent monocyclic aromatic groups are preferable.

Also, Ar¹¹ to Ar¹⁸ may be substituted by an alkyl group having 1 to 18 carbons, an alkoxy group having 1 to 10 carbons, an aryl group having 6 to 10 carbons, an aryloxy group having 6 to 18 carbons or an acyl group having 2 to 20 carbons.

Specific examples of the proton-conducting polymer are the following structures (1) to (26):

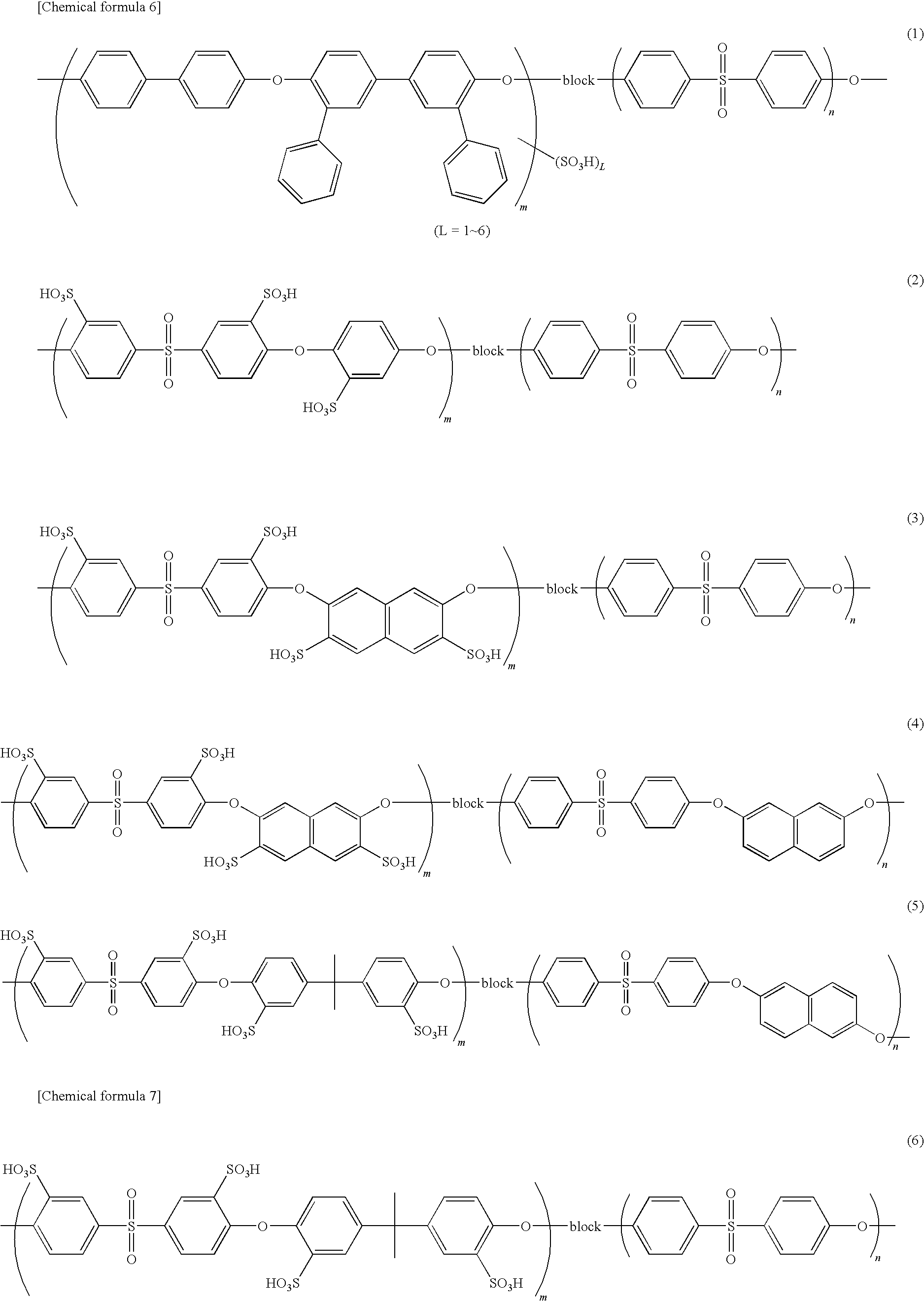

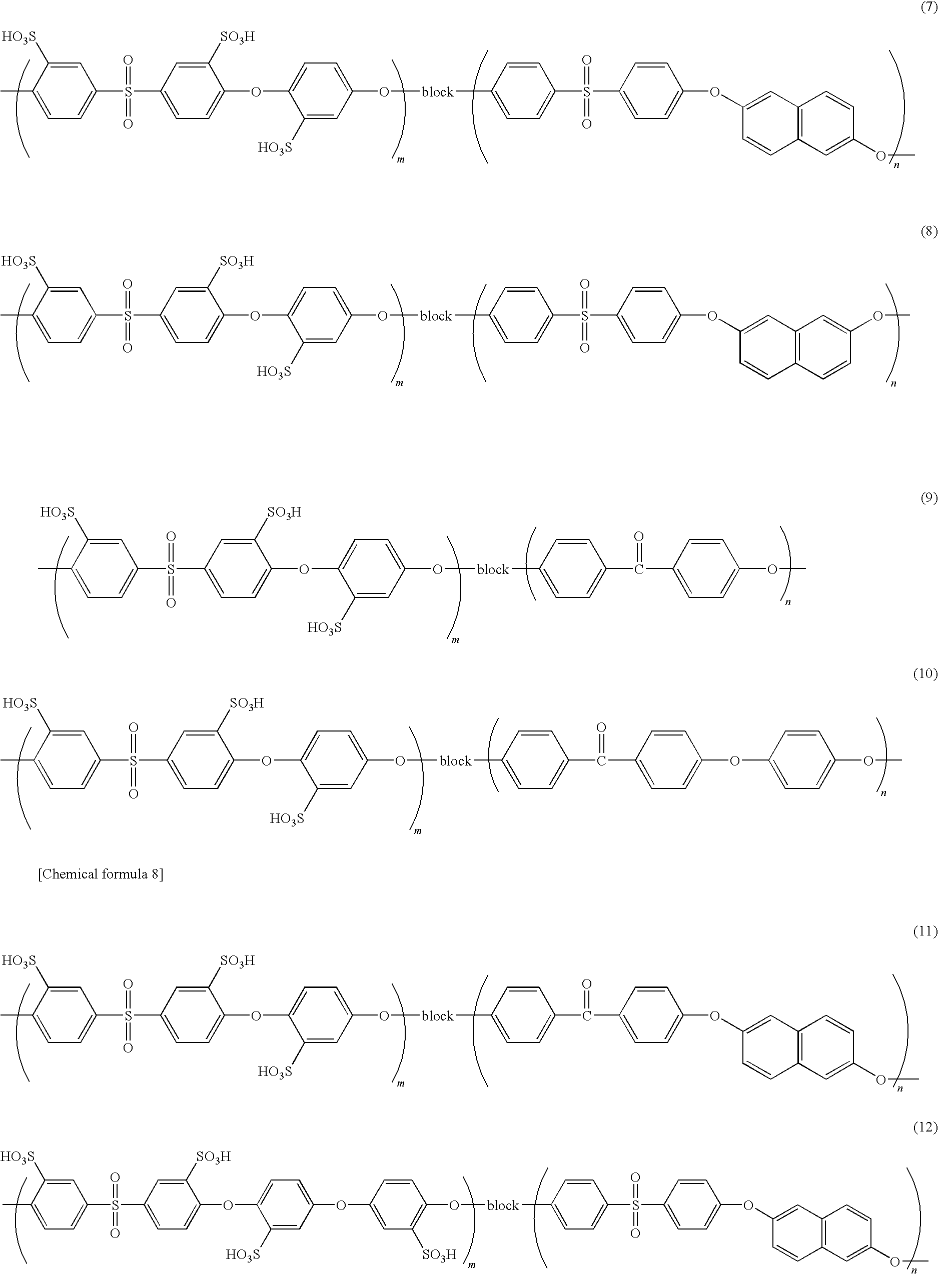

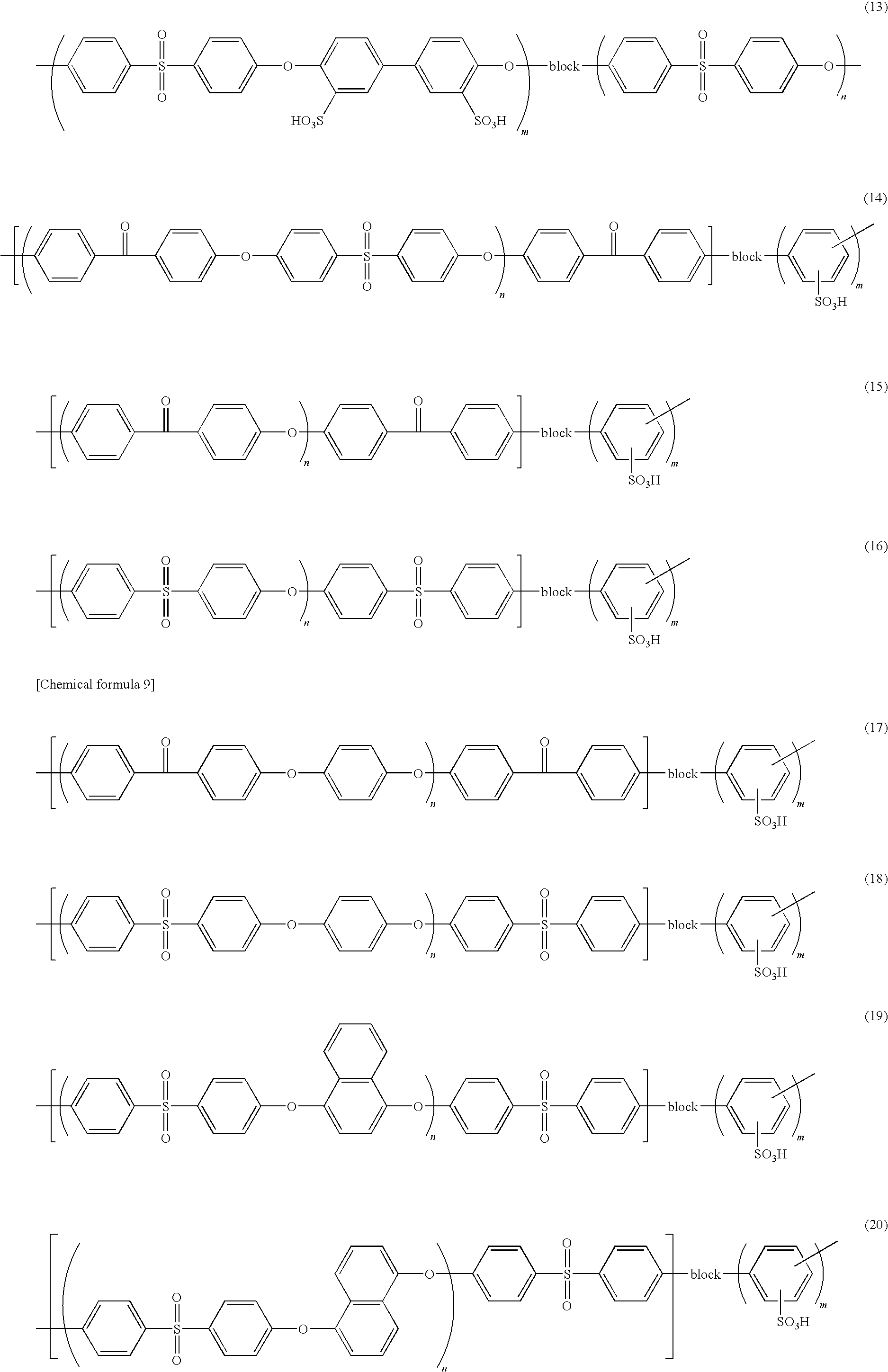

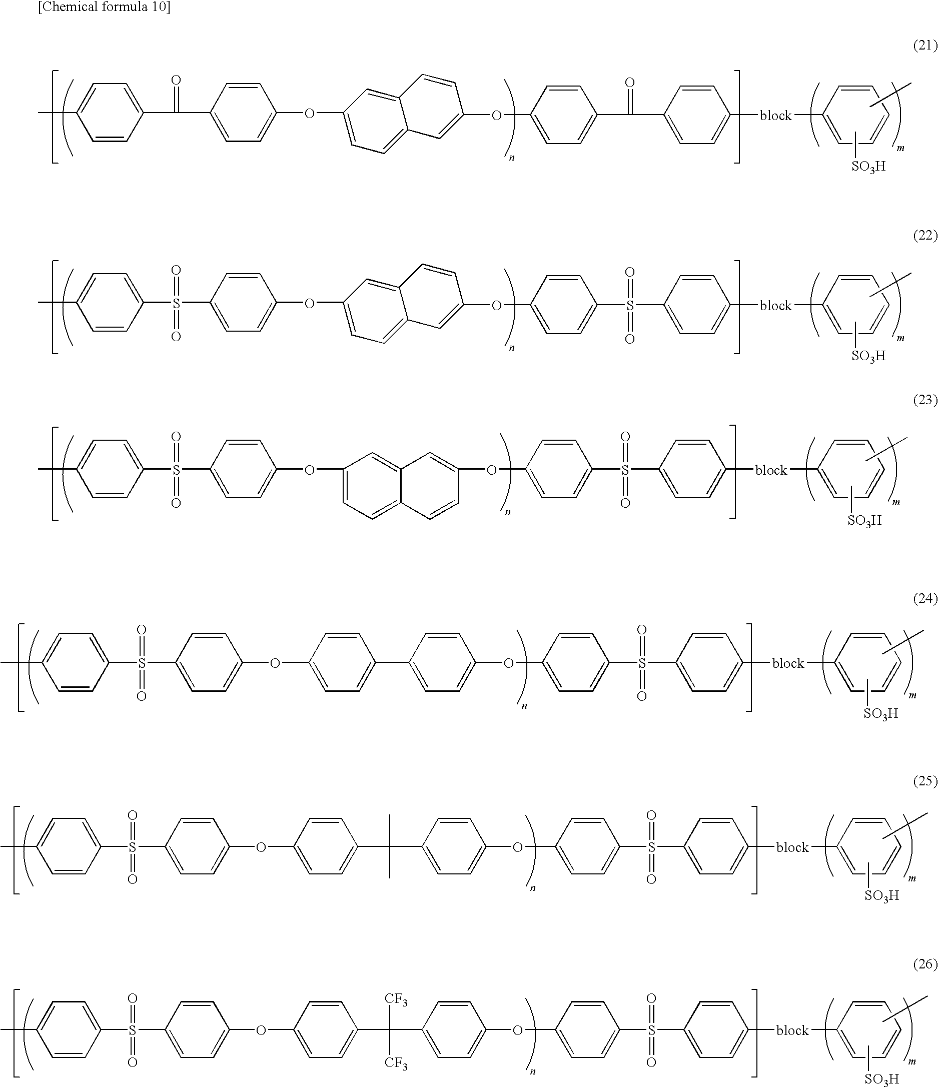

Examples of more preferred proton-conducting polymer are the above (2), (7), (8), (16), (18) and (22) to (25). Particularly preferable examples are (16), (18), (22), (23) and (25).

In the case that the proton-conducting polymer is a block copolymer comprising one or more blocks (A) having the proton-exchange group and one or more blocks (B) substantially having no proton-exchange group, it is particularly preferable that both block (A) having the proton-exchange group and block (B) substantially having no proton-exchange group substantially have no substituent containing a halogen atom such as fluorine, chlorine or sulfur.

The term “substantially having no substituent” as used herein means that the substituent may be contained to an extent that the effect of the present invention is unaffected. Specifically, the term “substantially having no substituent containing a halogen atom” means that the amount of the substituent containing the halogen atom per repeating unit is less than 0.05. It is not preferable that the block copolymer contains the halogen atom since, for example, hydrogen fluoride, hydrogen chloride, hydrogen bromide, hydrogen iodide or the like may generate during the operation of fuel cell to corrode fuel cell materials.

On the other hand, each block (A) and (B) may have the following substituent. Examples are an alkyl group, an alkoxy group, an aryl group, an aryloxy group and an acyl group, preferably the alkyl group. These substituents preferably have 1 to 20 carbons. Examples are substituents with small number of carbon such as a methyl group, an ethyl group, a methoxy group, an ethoxy group, a phenyl group, a naphthyl group, a phenoxy group, a naphthyloxy group, an acetyl group and a propionyl group.

Also, the molecular weight of the proton-conducting polymer is preferably from 5,000 to 1,000,000, particularly preferably from 15,000 to 400,000, in terms of the polystyrene calibrated-number average molecular weight.

The solution-cast method uses the polymer electrolyte in the state of solution to form the membrane. Specifically, at least one or more kinds of proton-conducting polymers are dissolved in an appropriate solvent together with other components such as a polymer other than the proton-conducting polymer and additive, if necessary, and the solution (polymer electrolyte solution) is casted and coated on a specific substrate followed by removing the solvent, thus the polymer electrolyte membrane is formed.

When preparing the polymer electrolyte solution, two or more kinds of components which constitute the polymer electrolyte membrane may be separately added, such as separately adding two or more kinds of proton-conducting polymers into the solvent, or separately adding the proton-conducting polymer and other components into the solvent. Then, the mixture is dissolved to prepare the polymer electrolyte solution.

Any solvent may be used for forming membrane if a polyarylene polymer is soluble and it can be removed later. Suitably used examples are aprotic polar solvents such as dimethylformamide (DMF), dimethylacetamide (DMAc), N-methyl-2-pyrrolidone (NMP) and dimethyl sulfoxide (DMSO), chlorinated solvents such as dichloromethane, chloroform, 1,2-dichloroethane, chlorobenzene and dichlorobenzene, alcohols such as methanol, ethanol and propanol, and alkylene glycol monoalkyl ether such as ethylene glycol monomethyl ether, ethylene glycol monoethyl ether, propylene glycol monomethyl ether and propylene glycol monoethyl ether. These can be used alone or in combination of two or more kinds of solvents, if necessary. Among them, DMSO, DMF, DMAc and NMP are preferable due to high polymer solubility.

In order to enhance chemical stability such as oxidation resistance and radical resistance of the polymer electrolyte membrane, a chemical stabilizer may be added together with the proton-conducting polymer to the extent that the effect of the present invention is not prevented. As the stabilizer to be added, there may be an antioxidant or the like. Examples are additives disclosed in Patent Document 8 (JP-A No. 2003-201403), Patent Document 9 (JP-A No. 2003-238678) and Patent Document 10 (JP-A No. 2003-282096). Alternatively, as the chemical stabilizer, a polymer containing a phosphonate group represented by the following formula disclosed in Patent Document 11 (JP-A No. 2005-38834) and Patent Document 12 (JP-A No. 2006-66391) may be contained:

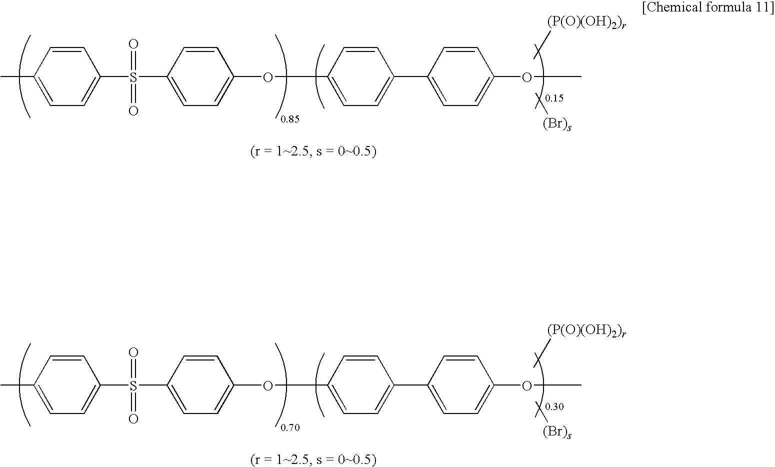

wherein, each subscripted number of repeating unit represents mole fraction of the repeating unit.

The content of the chemical stabilizer to be added is preferably within 20 wt % of the total. If the content exceeds the above range, there is a possibility that property of the polymer electrolyte membrane may decline.

In the solution-cast method, a substrate which can continuously form a membrane is preferably used as the substrate for casting and coating. The substrate which can continuously form a membrane means a substrate which can be kept as a scroll and can withstand a certain level of external force such as inflection without breaking.

It is preferable that the substrate to be casted and coated has heat resistance and dimensional stability to such a degree that the substrate can withstand dry conditions when forming the membrane by casting. Also, a resin substrate having solvent resistance with respect to the above-mentioned solvent and water resistance, especially a resin film, is preferable. Also, a resin substrate which can be separated without firmly bonding with the polymer electrolyte membrane after coating and drying is preferable. The term “have heat resistance and dimensional stability” as used herein means that the substrate does not deform by heat in the case of drying the polymer electrolyte solution to remove the solvent by means of a drying oven after casting and coating the polymer electrolyte solution. Also, the term “have solvent resistance” means that the substrate (film) itself is not substantially dissolved by the solvent in the polymer electrolyte solution. In addition, the term “have water resistance” means that the substrate (film) itself is not substantially dissolved in an aqueous solution having pH with 4.0 to 7.0. Further, the term “have solvent resistance” and “have water resistance” are concept which includes that chemical deterioration is not caused with respect to the solvent and water and dimensional stability is excellent without causing swelling and contracting.

As the substrate which can easily enlarge the contact angle on the substrate side of the polymer electrolyte membrane by casting and coating, a substrate whose surface subject to casting and coating is formed by a resin is suitable and a resin film is generally used.

Examples of the substrate made of the resin film are a polyolefin film, a polyester film, a polyamide film, a polyimide film and a fluorine film. In particular, the polyester film and the polyimide film are preferable since they are excellent in heat resistance, dimensional stability resistance and solvent resistance. Examples of the polyester film are polyethylene terephthalate, polyethylene naphthalate, polybutylene terephthalate and aromatic polyester. Particularly, polyethylene terephthalate is industrially preferable not only from the viewpoint of the above-mentioned characteristic, but also from the viewpoint of general versatility and cost.

Since the resin film can be along-continuous flexible substrate, it can be retained and utilized as a scroll, and it can be suitably used in the case that the polymer electrolyte membrane is continuously formed.

The substrate may be subject to a surface treatment which can change wettability of the surface of the substrate as usage. Examples of the treatment which can change the wettability of the surface of the substrate as used herein are general methods including a hydrophilization treatment such as a corona treatment and a plasma treatment, and a water-repellent treatment such as a fluorine treatment.

Hereinafter, an embodiment of a membrane electrode assembly in which the above-mentioned polymer electrolyte membrane is interposed between a pair of electrodes, and a fuel cell provided with the membrane electrode assembly will be described.

A gas diffusion layer which constitutes the electrode can be formed with the use of a gas diffusion layer sheet made of, for example, a conductive porous body, examples of which are a carbonaceous porous body such as a carbon paper, a carbon cloth or a carbon felt and a metallic mesh or metallic porous body constituted by metal such as titanium, aluminum, copper, nickel, a nickel chrome alloy, copper, a copper alloy, silver, an aluminum alloy, a zinc alloy, a lead alloy, titanium, niobium, tantalum, iron, stainless, gold or platinum, which has gas diffuseness sufficient to efficiently supply gas to the catalyst layer, conductive property and strength required as material to constitute the gas diffusion layer. The thickness of the conductive porous body is preferably from about 50 μm to about 500 μm.

The gas diffusion layer sheet may be formed by a single layer of the above-mentioned conductive porous body, however, a water-repellent layer may be provided on the surface which faces to the catalyst layer. The water-repellent layer generally has a porous structure containing conductive particulates such as carbon particle and carbon fiber and a water-repellent resin such as polytetrafluoroethylene (PTFE) or the like.

A method of forming the water-repellent layer on the conductive porous body is not particularly limited, for example, a water-repellent layer ink, in which the conductive particulates such as carbon particles, the water-repellent resin and other components if necessary, are mixed into a solvent including an organic solvent such as ethanol, propanol or propylene glycol, water, or a mixture thereof, is coated on the surface which at least faces the catalyst layer of the conductive porous body, and then dried and/or baked.

In addition, the conductive porous body may be processed by impregnating and coating the water-repellent resin such as polytetrafluoroethylene on the surface which faces the catalyst layer by means of a bar coater or the like in order to efficiently discharge moisture in the catalyst layer out of the gas diffusion layer.

The catalyst layer generally contains the proton-conducting polymer besides the electrode catalyst having the catalyst activity for the electrode reaction. As the electrode catalyst, it is not particularly limited if the electrode catalyst has the catalyst activity for the electrode reaction, and the electrode catalyst which is generally used can be used. Generally, examples are metal such as platinum, ruthenium, iridium, rhodium, palladium, lead, iron, chromium, cobalt, nickel, manganese, vanadium, molybdenum, gallium, aluminum and alloy thereof. Platinum and platinum-alloy such as platinum-ruthenium alloy are preferable.

The electrode catalyst is normally carried by a conducting particle to facilitate the transfer of electron in the electrode reaction at the electrode catalyst and to ensure dispersibility of the electrode catalyst in the electrode. As the conducting particle, metallic particle or the like can be used besides carbon particle such as carbon black. The conducting particle is not limited to spherical shape. A shape which has relatively high aspect ratio such as fibrous form is also included.

The proton-conducting polymer which is contained in the catalyst layer is not particularly limited. The proton-conducting polymer which is generally used in the solid polymer fuel cell can be used. For example, a hydrocarbon polymer electrolyte resin in which the proton-exchange group such as a sulfonic acid group, a boronic acid group, a phosphonic acid group or a hydroxyl group is introduced to a hydrocarbon resin such as polyether sulfone, polyimide, polyether ketone, polyether ether ketone or polyphenylene may be used besides a fluorinated electrolyte resin such as a perfluorocarbon sulfonic acid resin, typically Nafion (product name, manufactured by DuPont). Specifically, there may be the aforementioned examples for the proton-conducting polymer constituting the polymer electrolyte membrane.

In addition, other components including a water-repellent polymer (for example, polytetrafluoroethylene or the like) and a binder may be contained in the catalyst layer if necessary, besides the conducting particle which carries the electrode catalyst and the proton-conducting polymer.

A method of producing the membrane electrode assembly is not particularly limited. For example, the catalyst layer can be formed by using the catalyst ink, wherein each component which forms the catalyst layer is dissolved and dispersed in a solvent. Specifically, the catalyst ink is directly coated on the surface of the electrolyte membrane, or the catalyst ink is directly coated on the gas diffusion layer sheet which serves as the gas diffusion layer, or the catalyst ink is coated on a transfer substrate, then dried to produce a catalyst layer transfer sheet and a catalyst layer on the transfer sheet is transferred on the electrolyte membrane or the gas diffusion layer sheet, thereby the catalyst layer is formed on the surface of the electrolyte membrane or the gas diffusion layer.

A method of coating the catalyst ink is not particularly limited. Examples are a spraying method, a screen printing method, a doctor blade method, a gravure printing method and a die-coating method.

The electrolyte membrane-catalyst layer assembly, which is provided with the catalyst layer on each surface of the electrolyte membrane by the direct coating of the catalyst ink or the transfer of the of the transfer sheet, is generally bound together with the gas diffusion layer sheets by carrying out thermal compression in the state that the electrolyte membrane-catalyst layer assembly is interposed between the gas diffusion layer sheets. Thereby, the membrane electrode assembly provided with the electrode having the catalyst layer and the gas diffusion layer on both surfaces of the electrolyte membrane can be obtained.

The gas diffusion layer-catalyst layer assemblies, each of which is provided with the catalyst layer on the surface of the gas diffusion layer sheet by the direct coating of the catalyst ink or the transfer of the transfer sheet, are bound together with the electrolyte membrane by carrying out thermal compression in the state that the gas diffusion layer-catalyst layer assemblies interpose the electrolyte membrane. Thereby, the membrane electrode assembly provided with the electrode having the catalyst layer and the gas diffusion layer on both surfaces of the electrolyte membrane can be obtained.

The membrane electrode assembly produced in this way constitutes a cell by being interposed by separators which are formed by carbonaceous materials or metallic materials, and is incorporated into the fuel cell.

### EXAMPLES

### Production of Electrolyte Membrane

### Synthesis Example 1

Under argon atmosphere, 142.2 parts by weight of DMSO, 55.6 parts by weight of toluene, 5.7 parts by weight of sodium 2,5-dichlorobenzenesulfonate, 2.1 parts by weight of polyether sulfone (product name: SUMICAEXCEL PES 5200P, manufactured by Sumitomo Chemical Co., Ltd.), which is chloro-terminal type in the following formula (29) and 9.3 parts by weight of 2,2′-bipyridyl were charged in a flask provided with an azeotropic distillation apparatus and agitated:

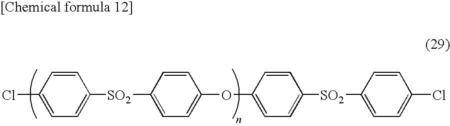

Then, bath temperature was raised up to 100° C. to distil the toluene away under reduced pressure so as to allow moisture in the system to be subjected to azeotropic dehydration. After cooling it to 65° C., the pressure was returned to normal pressure.

Next, 15.4 parts by weight of bis(1,5-cyclooctadiene) nickel (0) was added, and then it was raised to 70° C. and agitated for 5 hours at the same temperature. After leaving it to cool, polymer was deposited by pouring reaction solution to a large amount of methanol, and then filtered to separate. Subsequently, washing and filtration by using 6 mol/L of hydrochloric acid were repeated several times, water washing was carried out until the filtrate was neutralized, and then it was dried under reduced pressure. Thereby, an objective substance, 3.0 parts by weight of polyarylene block copolymer (IEC=2.2 meq/g, Mn=103,000, Mw=257,000) represented by the following formula (16′) was obtained:

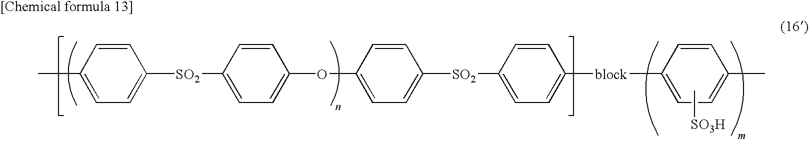

The obtained proton-conducting polymer represented by the formula (16′) was dissolved in dimethylsulfoxide to prepare a solution with concentration of 10 wt %. The solution was subjected to casting and coating on a substrate made of polyethylene terephthalate (PET) and dried to produce a hydrocarbon polymer electrolyte membrane. The surfaces of the obtained hydrocarbon polymer electrolyte membrane on the PET substrate side and the air interface side were subjected to water contact angle measurement. Results are shown in Table 1.

### (Measurement of Water Contact Angle)

The polymer electrolyte membrane was left for 24 hours in an atmosphere at 23° C. under 50 RH %, followed by putting a drop of water having a diameter of 2.0 mm on the surface of the polymer electrolyte membrane and measuring the contact angle with respect to the drop of water after 5 seconds by sessile drop method by means of contact angle measuring system (CA-A type, manufactured by Kyowa Interface Science Co., Ltd.).

TABLE 1

| | Water contact angle |
|---|---|
| The first surface (air interface side surface) | 38° |
| The second surface (PET substrate side surface) | 89° |

As shown in Table 1, the hydrocarbon polymer electrolyte membrane produced by the solution-cast method using the proton-conducting polymer represented by the formula (16′) has large difference of water contact angle on the PET substrate side surface, which was contacted with the PET substrate when forming the membrane, and on the air interface side surface. The hydrophilicity of the air interface side surface (water contact angle: 38°) was larger compared with that of the PET substrate side surface (water contact angle: 89°).

### Evaluation of Power Generation Performance

### (Production of Membrane Electrode Assembly)

1 g of Pt/C catalyst (rate of supported Pt: 50 wt %), 4 ml of 10 wt % solution of perfluorocarbon sulfonic acid (product name: Nafion), 5 ml of ethanol and 5 ml of water were mixed by means of ultrasonic washing machine and centrifugal agitator to prepare a slurry catalyst ink.

The obtained catalyst ink was coated by spray on both surfaces of the hydrocarbon polymer electrolyte membrane and a catalyst layer (13 cm²) was formed. In this case, the catalyst ink was coated so that a Pt amount per unit area of the catalyst layer is 0.6 mg/cm².

The obtained electrolyte membrane with catalyst layer was interposed between carbon cloths for gas diffusion layers, thereby a membrane electrode assembly was obtained.

The obtained membrane electrode assembly was interposed between two sheets of carbon separator, thereby a unit cell was produced.

### (Power Generation Test)

### Example 1

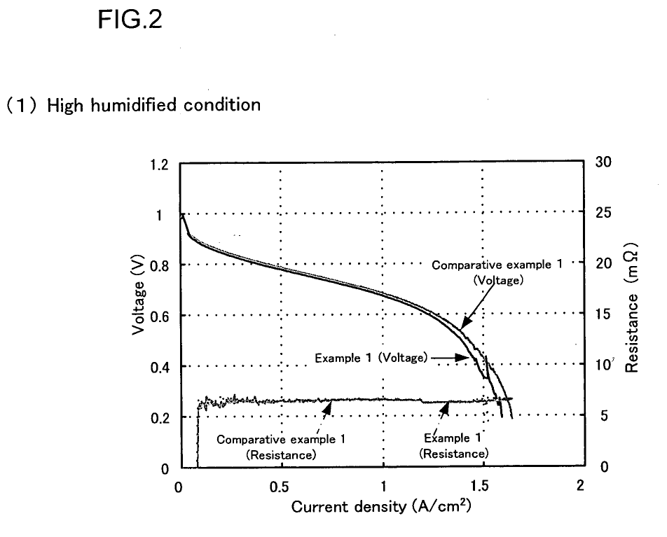

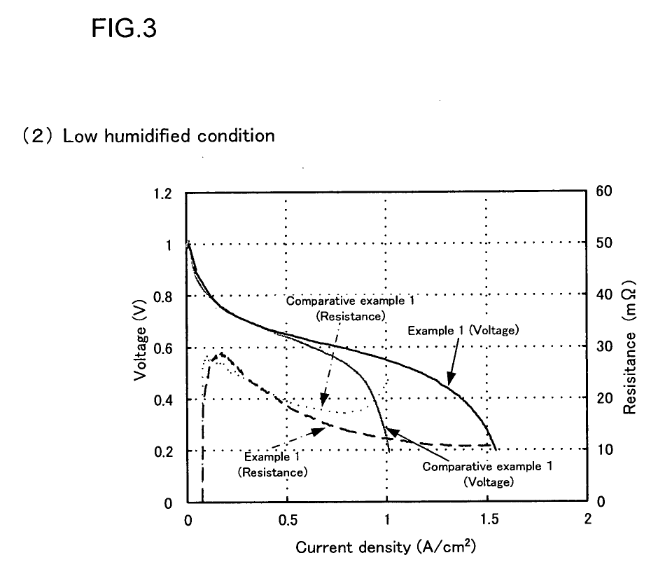

Hydrogen gas and air were supplied to a unit cell so that the first surface of the hydrocarbon polymer electrolyte membrane (high hydrophilicity, air interface side surface) served as the fuel electrode side, the second surface (low hydrophilicity, PET substrate side surface) served as the oxidant electrode side. The power generation test was carried out under the following “(1) High humidified condition” and “(2) Low humidified condition”. Results are shown in FIG. 2 (high humidified condition) and FIG. 3 (low humidified condition).

### <Condition of Power Generation Evaluation>

### (1) High Humidified Condition

Hydrogen gas: 272 ml/min

Air: 866 ml/min

Cell temperature: 80° C.

Anode side bubbler temperature: 80° C.

Cathode side bubbler temperature: 80° C.

Back pressure: 0.1 MPa (gauge pressure)

### (2) Low Humidified Condition

Hydrogen gas: 272 ml/min

Air: 866 ml/min

Cell temperature: 80° C.

Anode side bubbler temperature: 45° C.

Cathode side bubbler temperature: 55° C.

Back pressure: 0.1 MPa (gauge pressure)<

### Comparative Example 1

Hydrogen gas and air were supplied to a unit cell so that the first surface of the hydrocarbon polymer electrolyte membrane (high hydrophilicity, air interface side surface) served as the oxidant electrode side, the second surface (low hydrophilicity, PET substrate side surface) served as the fuel electrode side. The power generation test was carried out under the above “(1) High humidified condition” and “(2) Low humidified condition” in the same manner as Example 1. Results are shown FIG. 2 (high humidified condition) and FIG. 3 (low humidified condition).

As shown in FIG. 2 and FIG. 3, the unit cell provided with the membrane electrode assembly of Example 1, wherein the surface (the first surface) having relatively high hydrophilicity of the polymer electrolyte membrane was the fuel electrode side and the surface (the second surface) having relatively low hydrophilicity of the polymer electrolyte membrane was the oxidant electrode side, had excellent power generation performance under both the high humidified condition and low humidified condition.

By contrast, the unit cell provided with the membrane electrode assembly of Comparative example 1, wherein the surface (the first surface) having relatively high hydrophilicity of the polymer electrolyte membrane was the oxidant electrode side and the surface (the second surface) having relatively low hydrophilicity of the polymer electrolyte membrane was the fuel electrode side, exhibited power generation performance equal to that of Example 1 under high humidified condition. However, under low humidified condition, voltage was decreased rapidly around 0.8 A/cm² of current density. Therefore, power generation performance in high current density region was inferior to that of Example 1.

That is, in the unit cell of Example 1, wherein the polymer electrolyte membrane having different hydrophilicity on both surfaces thereof was used so that the surface having high hydrophilicity (the first surface) served as the fuel electrode side, the transfer of water (back diffusion) from the oxidant electrode side (low hydrophilicity) to the fuel electrode side (high hydrophilicity) in the polymer electrolyte membrane was facilitated. As a result, operation performance in high current density region under low humidified condition was improved. The unit cell provided with the membrane electrode assembly of the present invention had excellent power generation performance even under the condition that drying of the polymer electrolyte membrane is easily caused such as in high current density region under low humidified condition. Therefore, it is expected that the unit cell will exhibit excellent power generation performance even under high-temperature condition.

1. A membrane electrode assembly for fuel cell comprising:
a polymer electrolyte membrane containing at least one or more kinds of proton-conducting polymers, a fuel electrode disposed on one surface of the polymer electrolyte membrane and an oxidant electrode disposed on the other surface thereof,
wherein, hydrophilicity of one surface of the polymer electrolyte membrane differs from that of the other surface of the polymer electrolyte membrane, in which a surface having relatively high hydrophilicity is defined as a first surface and a surface having relatively low hydrophilicity is defined as a second surface, the fuel electrode is disposed on the first surface of the polymer electrolyte membrane, and the oxidant electrode is disposed on the second surface thereof.

2. The membrane electrode assembly for fuel cell according to claim 1, wherein when the hydrophilicity of the surface of the polymer electrolyte membrane is specified with water contact angle, the water contact angle on the first surface is relatively small and the water contact angle on the second surface is relatively large.

3. The membrane electrode assembly for fuel cell according to claim 2, wherein a difference of water contact angle between the first surface and the second surface is larger than 30°.

4. The membrane electrode assembly for fuel cell according to claim 2, wherein the water contact angle on the first surface is from 10° to 60°, and the water contact angle on the second surface is 60° or more.

5. The membrane electrode assembly for fuel cell according to claim 2, wherein when the hydrophilicity on the surface of the polymer electrolyte membrane is specified with the water contact angle, the water contact angle on the second surface is 110° or less.

6. The membrane electrode assembly for fuel cell according to claim 1, wherein the polymer electrolyte membrane is a hydrocarbon polymer electrolyte membrane.

7. The membrane electrode assembly for fuel cell according to claim 6, wherein the proton-conducting polymer has an aromatic ring in a main chain and a proton-exchange group which is bonded to the aromatic ring directly or indirectly through one or more other atoms or atomic groups.

8. The membrane electrode assembly for fuel cell according to claim 7, wherein the proton-conducting polymer has a side chain.

9. The membrane electrode assembly for fuel cell according to claim 6, wherein the proton-conducting polymer has an aromatic ring in a main chain and optionally has a side chain with an aromatic ring, and at least one of the aromatic rings of the main chain or the side chain has the proton-exchange group which is directly bonded to the aromatic ring.

10. The membrane electrode assembly for fuel cell according to claim 7, wherein the proton-exchange group is a sulfonic acid group.

11. The membrane electrode assembly for fuel cell according to claim 9, wherein the proton-conducting polymer contains one or more repeating units having the proton-exchange group selected from the following formulas (1a) to (4a) and one or more repeating units substantially having no proton-exchange group selected from the following formulas (1b) to (4b): 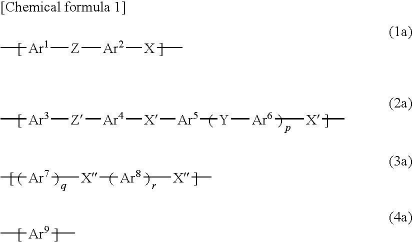
wherein, each of from Ar¹ to Ar⁹ represents a divalent aromatic group having an aromatic ring in a main chain and may further have a side chain with an aromatic ring; at least one of the aromatic rings of the main chain or the side chain has a proton-exchange group which is directly bonded to the aromatic ring; each of “Z” and “Z′” independently represents either CO or SO₂; each of “X”, “X′” and “X″” independently represents either O or S; “Y” represents a direct bonding or a methylene group which may have a substituent; “p” represents 0, 1 or 2; and each of “q” and “r” independently represents 1, 2 or 3, and 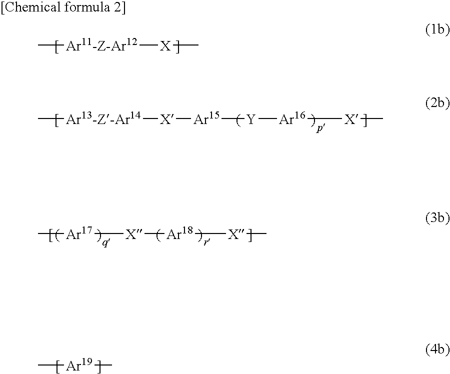
wherein, each of from Ar¹¹ to Ar¹⁹ independently represents a divalent aromatic group which may have a substituent as a side chain; each of “Z” and “Z′” independently represents either CO or SO₂; each of “X”, “X′” and “X″” independently represents either O or S; “Y” represents a direct bonding or a methylene group which may be have a substituent; “p′” represents 0, 1 or 2; and each of “q′” and “r′” independently represents 1, 2 or 3.

12. The membrane electrode assembly for fuel cell according to claim 7, wherein the proton-conducting polymer is a block copolymer containing a block (A) having the proton-exchange group and a block (B) substantially having no proton-exchange group.

13. The membrane electrode assembly for fuel cell according to claim 7, wherein the polymer electrolyte membrane has a microphase-separated structure separated into at least two or more phases.

14. The membrane electrode assembly for fuel cell according to claim 13, wherein the polymer electrolyte membrane comprises a block copolymer containing a block (A) having the proton-exchange group and a block (B) substantially having no proton-exchange group as the proton-conducting polymer, and has the microphase-separated structure containing a phase with high density of the block (A) having the proton-exchange group and a phase with high density of the block (B) substantially having no proton-exchange group.

15. The membrane electrode assembly for fuel cell according to claim 12, wherein the proton-conducting polymer contains one or more blocks (A) having the proton-exchange group and one or more blocks (B) substantially having no proton-exchange group, in which the block (A) having the proton-exchange group has a repeating structure represented by the following formula (4a′), and the block (B) substantially having no proton-exchange group has one or more repeating structures selected from repeating structures represented by the following formula (1b′), (2b′) or (3b′): 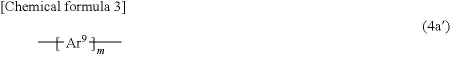
wherein, “m” represents an integer of 5 or more; Ar⁹ represents a divalent aromatic group; the divalent aromatic group as used herein may be substituted by a fluorine atom, an alkyl group having 1 to 10 carbons, an alkoxy group having 1 to 10 carbons, an aryl group having 6 to 18 carbons, an aryloxy group having 6 to 18 carbons or an acyl group having 2 to 20 carbons; and Ar⁹ has at least one proton-exchange group which is bonded to an aromatic ring constituting a main chain directly or indirectly through a side chain, and 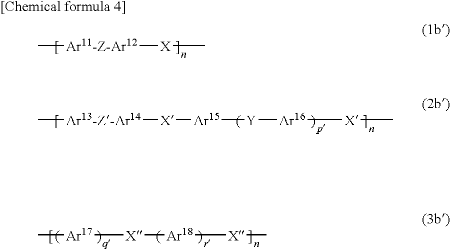
wherein, “n” represents an integer of 5 or more; each of from Ar¹¹ to Ar¹⁸ independently represents a divalent aromatic group; the divalent aromatic group as used herein may be substituted by an alkyl group having 1 to 18 carbons, an alkoxy group having 1 to 10 carbons, an aryl group having 6 to 10 carbons, an aryloxy group having 6 to 18 carbons or an acyl group having 2 to 20 carbons; other symbols are the same as shown in the formulas (1b) to (3b).

16. The membrane electrode assembly for fuel cell according to claim 12, wherein the proton-conducting polymer contains one or more blocks (A) having the proton-exchange group and one or more blocks (B) substantially having no proton-exchange group, and the proton-exchange group is directly bonded to the aromatic ring in the main chain of the block having the proton-exchange group.

17. The membrane electrode assembly for fuel cell according to claim 12, wherein the proton-conducting polymer contains one or more blocks (A) having the proton-exchange group and one or more blocks (B) substantially having no proton-exchange group, and both block (A) having the proton-exchange group and block (B) substantially having no proton-exchange group have no substituent containing a halogen atom.

18. The membrane electrode assembly for fuel cell according to claim 7, wherein no surface treatment is carried out on the second surface of the polymer electrolyte membrane.

19. The membrane electrode assembly for fuel cell according to claim 18, wherein no surface treatment is carried out on both first surface and second surface of the polymer electrolyte membrane.

20. The membrane electrode assembly for fuel cell according to claim 1, wherein the polymer electrolyte membrane is formed by casting, coating and drying a solution containing the proton-conducting polymer constituting the polymer electrolyte membrane on a substrate.

21. The membrane electrode assembly for fuel cell according to claim 20, wherein a surface of the substrate subject to casting and coating is formed by a resin.

22. The membrane electrode assembly for fuel cell according to claim 21, wherein the substrate is a resin film.

23. The membrane electrode assembly for fuel cell according to claim 22, wherein the substrate is a polyester film.

24. A fuel cell provided with the membrane electrode assembly for fuel cell defined by claim 1.

25. The membrane electrode assembly for fuel cell according to claim 9, wherein the proton-exchange group is a sulfonic acid group.

26. The membrane electrode assembly for fuel cell according to claim 9, wherein the proton-conducting polymer is a block copolymer containing a block (A) having the proton-exchange group and a block (B) substantially having no proton-exchange group.

27. The membrane electrode assembly for fuel cell according to claim 9, wherein the polymer electrolyte membrane has a microphase-separated structure separated into at least two or more phases.

28. The membrane electrode assembly for fuel cell according to claim 9, wherein no surface treatment is carried out on the second surface of the polymer electrolyte membrane.
